(19) United States
(12) Patent Application Publication
(10) Pub. No.: US 2025/0134299 A1
(43) Pub. Date: May 1, 2025

(54) Fluorinated Peek Composite Coating With High Mechanical Performance

(71) Applicant: SEB S.A., Ecully (FR)

(72) Inventors: Barbara Gantillon, Ecully Cedex (FR); Michel Fontaine, Ecully Cedex (FR); Hanlin Liao, Belfort (FR)

(73) Assignee: SEB S.A., Ecully (FR)

(21) Appl. No.: 18/720,223

(22) PCT Filed: Dec. 16, 2022
(86) PCT No.: PCT/FR2022/052412

§ 371 Date: Jun. 14, 2024

(30) Foreign Application Priority Data
Dec. 16, 2021 (FR) 2113654

(51) Int. Cl. A47J 36/02; B05D 5/08

(52) U.S. Cl. CPC A47J 36/025; B05D 5/086; B05D 2506/15; B05D 2518/00

(57) ABSTRACT

The present invention relates to a culinary article (I) comprising a hollow metal cap (2) which comprises a bottom (211) and a side wall (212) rising from the bottom (211), said cap (2) having a concave inner face (21) suitable for receiving food and a convex outer face (25), said inner face (21) being coated with a coating (5) consisting in series, from the cap (2), of a hard underlayer (3) and a non-stick coating (4), the non-stick coating (4) including at least one layer comprising at least one fluorocarbon resin, alone or in a mixture with at least one thermostable bonding resin that can withstand at least 200° C., characterised in that the hard underlayer (3) is provided as a discontinuous layer, in that said hard underlayer (3) consists of one or more non-fluorinated polymeric materials selected from polyaryletherketones (P AEK) and mixtures thereof, optionally of inorganic hard fillers, optionally of conductive fillers and optionally less than 3% by weight of additives relative to the weight of said hard underlayer, and in that the average equivalent diameter of the pores in the hard underlayer (3) is greater than 5 11 m and in that the coating (5) has an overall porosity fraction greater than 8%.

### CROSS-REFERENCE TO RELATED APPLICATIONS

The present application is a national phase entry under 35 U.S.C § 371 of International Application No. PCT/FR2022/052412 filed Dec. 16, 2022, which claims priority from French Application No. 2113654 filed Dec. 16, 2021, all of which are hereby incorporated herein by reference.

### BACKGROUND OF THE INVENTION

The invention applies to the field of non-stick coatings for cooking surfaces of culinary items and electrical cooking appliances.

PTFE (polytetrafluoroethylene)-coated culinary items are a popular choice because they allow cooking that requires little or no fat to be added and are easy to maintain. However, an inherent weakness of these coatings is their low mechanical resistance to cold and heat, especially heat.

To remedy this, many technical solutions have been proposed which consist in reinforcing the coating with hard fillers or by interposing hard inorganic or organic sublayers.

In the case of primers reinforced with hard organic or inorganic fillers, significant improvements in abrasion resistance are indeed observed, but impacts on the metal are nevertheless seen when cooking food products such as pork chops or when using metal spatulas.

In the case of hard inorganic bases such as, for example, those made from an enamel or from metal oxides, abrasion resistance is improved further and the problem of impacts is limited, but not eliminated.

Organic polymer sublayers are also known. These sublayers effectively help to considerably reduce the appearance of scratches or even eliminate them altogether. This strategy is therefore very advantageous. The polymers used are very often thermoplastics with high thermal resistance and a high melting point, for example polyaryletherketones and, in particular, oxy-1,4-phenylenephenylene-oxy-1,4-phenylene carbonyl-1,4-phenylene or PEEK or indeed phenylenesulfides.

PEEK is an advantageous polymer for culinary items because it has a high melting point (343° C.) and excellent thermal stability in conditions of use at 260° C.

The following coating techniques can be used to obtain a sublayer from this type of polymer: spray coating, roller coating, curtain coating, pad printing, screen printing, thermal spraying, electrostatic spray painting, ink jet.

Application WO 2000/54895 mentions the use of a sublayer composed only of PEEK (with particle sizes of between 5 μm and 100 μm, and with a D50 preferably of 20 μm) deposited on a metal substrate, with coverage of between 60% and 95% of the surface of the item, then covered with a single- or multi-layer non-stick coating made from fluorinated resins and fluorinated copolymers. The PEEK sublayer is deposited either by pad printing or screen printing, or as a dispersion spray.

The thickness of this layer of PEEK is between 5 μm and 100 μm.

The disadvantage of the method as described is that it requires double firing of the fluorinated coating made from PEEK. The first firing step requires a temperature higher than the melting point of the polymer forming the sublayer (i.e., between 380° C. and 400° C. for PEEK) in order to allow it to adhere to the metal substrate. The item then needs to be cooled down considerably, which is very costly in terms of time and energy, but essential in order to apply the successive fluorinated layers that will be sintered during a second high-temperature firing step (>420° C.).

Application WO 2010/130954 describes a hard sublayer forming a continuous network deposited discontinuously on the interior bottom of the culinary item. The material forming this layer is a ceramic (alumina-titanium mixture) or a metal or a polymer (PAI, PEI, PI, PES, PPS, PEK or PEEK). Between 30% and 80% of the surface of the culinary item is covered with this material and the dimension between the deposited drops is between 2 μm and 50 μm. The surface of this hard layer has roughness with an Ra of 2 μm to 12 μm, preferably 4 μm to 8 μm.

This material is sprayed, using a flame spraying method, in the form of a powder with a particle size preferably of between 20 μm and 45 μm.

The metal substrate needs to be preheated considerably before a flame spraying powder deposition method.

The fluorinated layers are then deposited by spray coating once the deposit has cooled to ambient temperature. A single sintering operation at 430° C. is then carried out.

Patent FR 2871038 mentions the use of a PEEK sublayer with a PAI resin and fluorinated resins deposited on a metal substrate and then covered with a non-stick coating in one or more layers and without the presence of PEEK in these upper layers.

The sublayer is formed from a mixture of PAI, PEEK and PTFE such that the PTFE is between 9% and 15% by weight and the PAI resin is between 4% and 5% by weight.

In all cases, the PEEK solids content in the final fluorinated film is of the order of 0.12% to 1.1% by weight, preferably 0.12% to 0.9% by weight.

The D50 particle size of the PEEK powder is between 5 μm and 35 μm.

In all cases, the first layer of coating contains fluorinated resins.

This liquid coating is deposited by spraying. Upper layers of fluorinated coatings also containing one or more bonding primers are then deposited by spraying. These layers are all sintered in a single firing step at between 400° C. and 420° C.

The disadvantage of this application method is that the amount of PEEK resin in the first layer is very low, making it impossible to achieve the mechanical performance required for a scratch-resistant coating.

Application WO 0054896 mentions the use of a sublayer of PEEK without fluorinated resin, constituted by at least 50% by weight of PEEK powder, so that the surface area covered with PEEK is between 60% and 95% of the surface area of the item.

This initial composition, which contains at least 50% PEEK, may also contain a mixture with other pure or mixed thermostable resins such as polyphenylene sulfide (PPS), polyetherimide (PEI), polyimide (PI), polyetherketone (PEK), polyethersulfone (PES) and polyamide-imide (PAI).

It may also contain fillers chosen from among metal oxides, silica, mica, or lamellar fillers. It does not contain any fluorinated resin.

The first firing step is carried out at a high temperature of at least 260° C., preferably greater than or equal to 340° C., in order to melt the PEEK.

The PEEK is in the form of a power with a particle size of between 4 μm and 80 μm, preferably with a D50 of 20 μm. The thickness of this sublayer is between 5 μm and 100 μm.

This liquid coating is deposited by spraying. Upper layers of fluorinated coatings or primers with fluorinated top layers are then deposited by spraying. These layers are all sintered in two firing steps at between 400° C. and 420° C.

Patent U.S. Pat. No. 6,596,380 B1 mentions a scratch-resistant fluorinated coating whose first layer contains at least 50% by weight of PEEK (preferably between 60% and 95%), mixed with a thermostable polymer resin such as PPS, PEI, PI, PAI and mixtures thereof and fillers such as metal oxides, silica, micas, and in the absence of any fluorinated resin. This first layer has a thickness of between 5 μm and 100 μm.

The PEEK is a powder with a particle size of 4 μm to 80 μm with a D50 of the order of 20 μm. However, the method for obtaining such a coating necessarily involves double firing/sintering at between 400° C. and 420° C.

In order to overcome all of these problems, the inventors have surprisingly obtained a hard sublayer, in direct contact with the aluminum, which is thick and discontinuous and, above all, has significant porosity, particularly macroporosity, as demonstrated by SEM-EDX and X-ray microtomography.

This sublayer makes it possible to obtain a non-stick coating with a novel structure, the layer or layers of fluorinated polymer applied by spraying onto said sublayer demonstrating specific anchoring in said porous sublayer, to the point of interdigitation. Therefore, the coating is adherent, resistant to delamination and extremely scratch-resistant.

In particular, the inventors have implemented this sublayer with a mixture of polymer (PEEK) and silicon carbide (SiC) powder sprayed using a flame spraying method in order to obtain a layer at the bottom of the item.

Fluorinated upper layers are then applied by spraying, achieving excellent coating adhesion. The presence of reinforcing fillers (alumina, silicon carbide, etc.) is also possible in the fluorinated layers. In particular, the coating that is obtained is produced with a single sintering procedure at 420-430° C. Excellent scratch-resistance performance is achieved while keeping the cost of the coating at industrially acceptable levels.

This sublayer also allows coating with a limited number of layers (a maximum of three) and a single sintering method in standard conditions, which makes the method industrializable without additional investment.

### Definitions

Within the meaning of the present invention, the expression “culinary item” should be understood to mean an object intended for cooking. Within the meaning of the present invention, culinary items comprise objects intended to be heated in order to cook or reheat food products carried by the cooking element or contained in the cooking element and electrical cooking appliances.

Within the meaning of the present invention, the expression “object intended to be heated in order to cook or reheat food products carried by the cooking element or contained in the cooking element” should be understood to mean an object that will be heated by an external heating system, such as a cooking hob, and that is capable of transmitting the heat energy supplied by this external heating system to a material or foodstuff in contact with said object. Such an object may, in particular, be a frying pan, a saucepan, a fondue or raclette pan or pot, a stew pot, a wok, a sauté pan, a crêpe pan, a cooking pot, a casserole dish or a cooking mold.

Within the meaning of the present invention, the expression “electrical cooking appliance” should be understood to mean an object intended for cooking, which is configured to produce heat.

Within the meaning of the present invention, the expression “object which is configured to produce heat” should be understood to mean a heating object having its own heating system.

Such an object may in particular be a grill, a plancha, a bowl for a cooking food processor or bread maker, an electric crêpe maker, an electric raclette appliance, an electric fondue appliance, an electric grill, an electric plancha, an electric cooking food processor or a bread maker.

“Equivalent pore diameter” should be understood to mean the diameter of the sphere having the same volume as the pore in question.

“Average equivalent pore diameter” should be understood to mean the average of the equivalent pore diameters.

“Median equivalent pore diameter” should be understood to mean the median of the equivalent pore diameters: 50% of the pores have an equivalent diameter smaller than this diameter and 50% a larger equivalent diameter.

### SUMMARY OF THE INVENTION

A first object of the invention relates to a culinary item (1) comprising a hollow metal cap (2) that comprises a bottom (211) and a sidewall (212) extending up from the bottom (211), said shell (2) having a concave interior face (21) designed to accept food products and a convex exterior face (22), said interior face (21) being coated with a coating (5) which consists successively, starting from the cap (2), of a hard sublayer (3) and a non-stick coating (4), the non-stick coating (4) comprising at least one layer comprising at least one fluorocarbon resin, alone or in a mixture with at least one thermostable bonding resin that can withstand at least 200° C., characterized in that the hard sublayer (3) is provided as a discontinuous layer, in that said hard sublayer (3) is made up of one or more non-fluorinated polymer materials chosen from polyaryletherketones (PAEK) and mixtures thereof, optionally hard inorganic fillers, optionally conductive fillers and optionally less than 3% by weight of additives relative to the weight of said hard sublayer, and in that the average equivalent pore diameter in the hard sublayer (3) is greater than 5 μm and in that the coating (5) has an overall porosity fraction greater than 8%.

A second object of the invention relates to a process for manufacturing a culinary item (1), characterized in that it comprises the following steps:
a) a step of providing a metal support (2) comprising two opposing faces;
b) a step of shaping said support (2) to give it the shape of a cap (2), which comprises a bottom (211) and a sidewall (212) extending up from the bottom (211), and thus defining a concave interior face (21) designed to accept food products and a convex exterior face (22), said step b) being carried out either before the step d) of producing the hard sublayer (3), or after the step e) of producing the non-stick coating (4);
c) optionally, a step of treating the interior face (21) of the support (2) in order to obtain a treated interior face (21) that promotes the adhesion of a hard sublayer (3) on the support (2);
d) a step of producing an adherent hard sublayer (3) on said interior face (21) or on said bottom (211) of the support (2) by thermal spraying of a powder or dispersion of a non-fluorinated polymer material chosen from polyaryletherketones (PAEK) and mixtures thereof, optionally hard inorganic fillers, optionally conductive fillers and optionally less than 3% by weight of additives relative to the weight of the hard sublayer (3), so as to form a discontinuous layer on said interior face (24) of the cap (2);
e) a step of producing a non-stick coating (4) on said hard sublayer (3) formed in step d);
f) a single final sintering step.

### DETAILED DESCRIPTION

A first object of the invention relates to a culinary item (1) comprising a hollow metal cap (2) that comprises a bottom (211) and a sidewall (212) extending up from the bottom (211), said cap (2) having a concave interior face (21) designed to accept food products and a convex exterior face (22), said interior face (21) or said bottom (211) being coated with a coating (5) which consists successively, starting from the cap (2), of a hard sublayer (3) and a non-stick coating (4), the non-stick coating (4) comprising at least one layer comprising at least one fluorocarbon resin, alone or in a mixture with at least one thermostable bonding resin that can withstand at least 200° C., characterized in that the hard sublayer (3) is provided as a discontinuous layer, in that said hard sublayer (3) is made up of one or more non-fluorinated polymer materials chosen from polyaryletherketones (PAEK) and mixtures thereof, optionally hard inorganic fillers, optionally conductive fillers and optionally less than 3% by weight of additives relative to the weight of said hard sublayer, in that the average equivalent pore diameter in the hard sublayer (3) is greater than 5 μm and in that the coating (5) has an overall porosity fraction greater than 8%.

“Discontinuous” should be understood to mean a layer that does not have a uniform thickness over the entire surface on which it is deposited. In some places, there may be no covering at all.

Advantageously, the polyaryletherketone or polyaryletherketones (PAEK) are chosen from the group constituted by: polyetherketones (PEK), polyetheretherketones (PEEK), polyetherketoneketones (PEKK), polyetheretherketoneketones (PEEKK) and polyetherketoneetherketoneketones (PEKEKK), in a particularly preferred manner being PEEK.

Preferably, the average thickness of the hard sublayer (3) is greater than 5 μm, or indeed greater than 20 μm, preferably greater than 50 μm, and more particularly between 40 μm and 80 μm. This average is, for example, the average of at least 10 measurements, and preferably 15 measurements, of the thickness at 10, or respectively 15, random locations.

The porosity data of the hard sublayer (3) and of the coating (5), in particular the overall porosity fraction, the average equivalent pore diameter and the median equivalent pore diameter are measured by X-ray microtomography using a synchrotron source.

Preferably, the average equivalent pore diameter is greater than 8 μm, and more preferably greater than 10 μm.

Preferably, the median equivalent pore diameter is greater than 6 μm, even more preferably greater than 7 μm, and more preferably still greater than 8 μm.

Preferably, more than 30%, even more preferably more than 40%, and in a particularly preferred manner more than 50% of the pores by number in the hard sublayer (3) have an average equivalent diameter ≤10 μm.

Preferably, more than 20%, and even more preferably more than 30% of the pores by number in the hard sublayer (3) have an average equivalent diameter >10 μm and ≤20 μm. Preferably, more than 60%, even more preferably more than 70%, and in a particularly preferred manner more than 80% of the pores by number in the hard sublayer (3) have an average equivalent diameter ≤20 μm.

Preferably, more than 5%, even more preferably more than 7%, and in a particularly preferred manner more than 10% of the pores by number in the hard sublayer (3) have an average equivalent diameter >20 μm and ≤30 μm.

Preferably, pores by number in the hard sublayer (3) have an equivalent pore diameter greater than 30 μm, and preferably at least 1% of the pores by number in the hard sublayer (3) have an equivalent pore diameter greater than 30 μm.

Preferably, the coating (5) has an overall porosity fraction greater than 10%. This refers to the closed porosity.

Preferably, more than 50% of the pore volume of the coating (5) is contained in the hard sublayer (3).

Preferably, the thickness of the coating (5) is between 15 μm and 200 μm, and more preferably still between 50 μm and 200 μm.

Preferably, the additives are chosen from pigments, surfactants and wetting agents. Preferably, said hard sublayer (3) comprises less than 1% by weight of additives.

Preferably, the hard inorganic fillers are particles of carbides of silicon or alumina or zirconia or graphite, or of carbon black, or of ceramics, or of one or more metal oxide or oxides.

In addition to their mechanical reinforcement performances, some hard inorganic fillers such as silicon carbide also have the advantage of being conductive fillers, and therefore provide excellent thermal conductivity.

Adding this type of filler helps improve cooking results, with better diffusion of heat from the metal substrate to the food products in contact with the coating. Preferably, the non-fluorinated polymer material or materials represent more than 50% by weight, and preferably more than 70% by weight of the hard sublayer.

According to one embodiment, the non-fluorinated polymer material or materials represent more than 97% by weight of the hard sublayer, the remainder optionally being made up to 100% by additives.

According to another embodiment, the hard inorganic fillers represent more than 20% by weight, and preferably more than 30% by weight of the hard sublayer.

Preferably, just after thermal spraying, the hard sublayer (3) has surface roughness Ra of between 8 μm and 100 μm, and more preferably of between 10 μm and 60 μm or between 10 μm and 40 μm.

Preferably, the fluorocarbon resin is chosen from polytetrafluoroethylene (PTFE), copolymer of tetrafluoroethylene and perfluoro (propyl vinyl ether) (PFA), copolymer of tetrafluoroethylene and hexafluoropropylene (FEP) and mixtures thereof.

Preferably, the bonding resin is chosen from polyamide-imides (PAI), polyetherimides (PEI), polyamides (PA), polyetherketones (PEK), polyetheretherketones (PEEK), polyethersulfones (PES), polyphenylene sulfides (PPS), tannins and mixtures thereof. More preferably still, the bonding resin is chosen from the polyamide-imides (PAI).

Preferably, the non-stick coating (4) comprises at least one top layer (42, 43).

Preferably, the cap (2) is a single-layer support made from aluminum or aluminum alloy, cast aluminum, stainless steel, cast steel or copper, or a multilayer support comprising the following layers from the outside towards the inside: ferritic stainless steel/aluminum/austenitic stainless steel or stainless steel/aluminum/copper/aluminum/austenitic stainless steel, or a cap of cast aluminum, aluminum or aluminum alloys lined with an outer bottom of stainless steel.

A second object of the invention relates to a process for manufacturing a culinary item (1), characterized in that it comprises the following steps:
a) a step of providing a metal support (2) comprising two opposing faces;
b) a step of shaping said support (2) to give it the shape of a cap (2), which comprises a bottom (211) and a sidewall (212) extending up from the bottom (211), and thus defining a concave interior face (21) designed to accept food products and a convex exterior face (22), said step b) being carried out either before the step d) of producing the hard sublayer (3), or after the step e) of producing the non-stick coating (4);
c) optionally, a step of treating the interior face (21) of the cap or the support (2) in order to obtain a treated interior face (21) that promotes the adhesion of a hard sublayer (3) on the cap (2);
d) a step of producing an adherent hard sublayer (3) on said interior face (21) or on said bottom (211) of the support (2) by thermal spraying of a powder or dispersion of a non-fluorinated polymer material chosen from polyaryletherketones (PAEK) and mixtures thereof, optionally hard inorganic fillers, optionally conductive fillers and optionally less than 3% by weight of additives relative to the weight of said hard sublayer (3), so as to form a discontinuous layer on said interior face (21) of the cap (2);
e) a step of producing a non-stick coating (4) on said hard sublayer (3) formed in step d);
f) a single final sintering step.

As the name suggests, thermal spraying consists in spraying a powder or a dispersion onto the surface.

Preferably, the metal support (2) in step a) is in the form of a disc.

The process according to the invention does not involve any other sintering step apart from that of step f).

Preferably, the thermal spraying is flame spraying or gas dynamic cold spraying (cold spraying).

In flame spraying, the spraying of powder fractions combined with the at least partial melting of the non-fluorinated polymer material explains the discontinuity of the hard sublayer (3).

Preferably, the material intended to be sprayed is a powdery material with a D50 particle size by volume of 5 μm to 60 μm, preferably 10 μm to 35 μm and even more preferably 8 μm to 30 μm.

Preferably, in flame spraying, the step d) of producing the hard sublayer (3) is preceded by a step of preheating said support or said cap (2) to a low temperature, depending on whether the shaping step b) is carried out before the step d) of producing the hard sublayer (3) or after the step e) of producing said non-stick coating (4). This preheating is carried out at a maximum temperature of 100° C.

Preferably, the step d) of producing the non-stick coating (4) comprises a step of depositing, on said hard sublayer (3), at least one composition comprising a fluorocarbon resin.

Preferably, in cold spraying, the step d) of producing the hard sublayer (3) is preceded by a step of preheating said support (2) or said cap (2) to between 150° C. and 300° C., depending on whether the shaping step b) is carried out before the step d) of producing the hard sublayer (3) or after the step e) of producing said fluorinated coating (4).

Preferably, the step d) is carried out by spraying, spread coating, screen printing or roller coating.

Preferably, the sintering step (f) is carried out in a furnace at a temperature of between 380° C. and 450° C.

The treatment step c) is preferably carried out by sandblasting, shot blasting, stamping, brushing or chemical etching.

FIG. 1: Photograph of the HOT BLADE test: 3 metal points rotating on the coating of the interior face of the culinary item, which is positioned on a heat source.

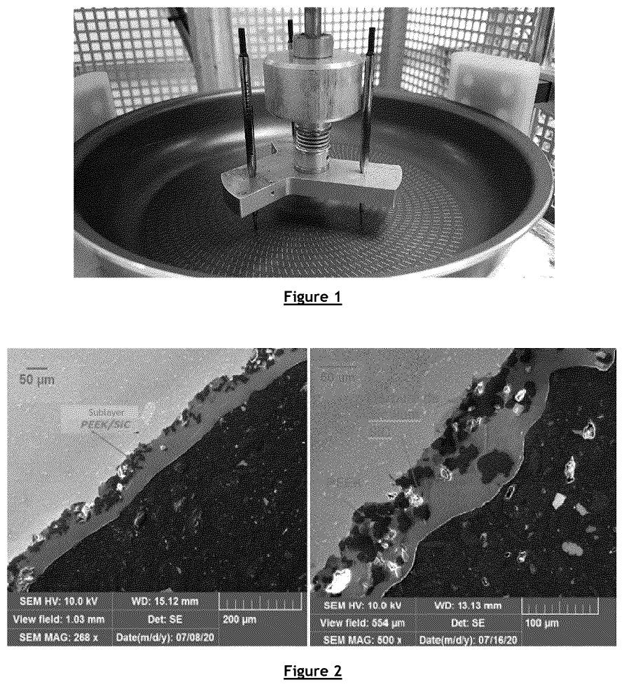

FIG. 2: Microtomography analysis, Example 1

FIG. 3: Porosity distribution, Example 1

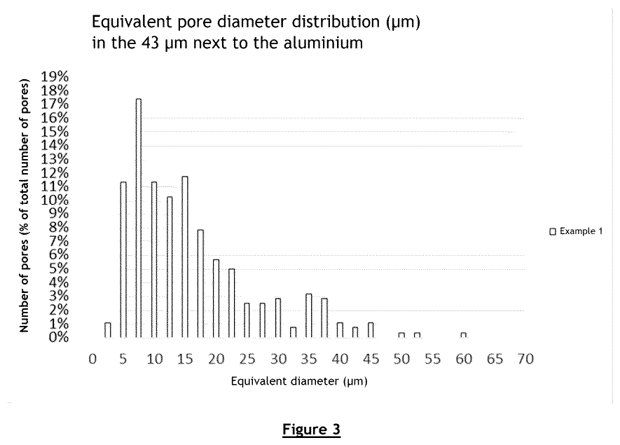

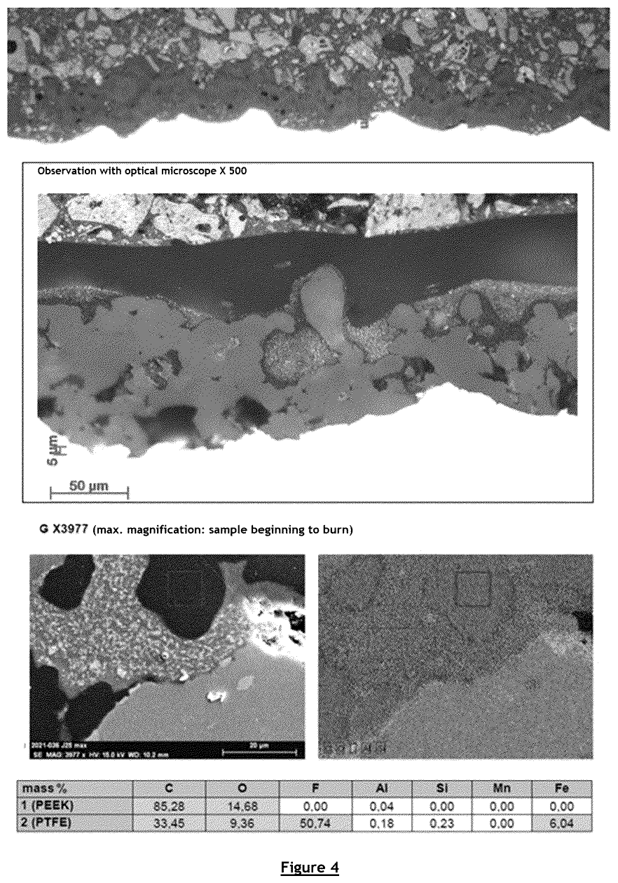

FIG. 4: SEM/EDX analysis, Example 2

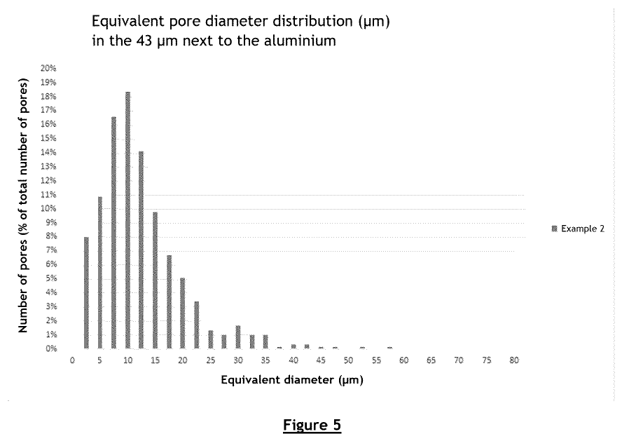

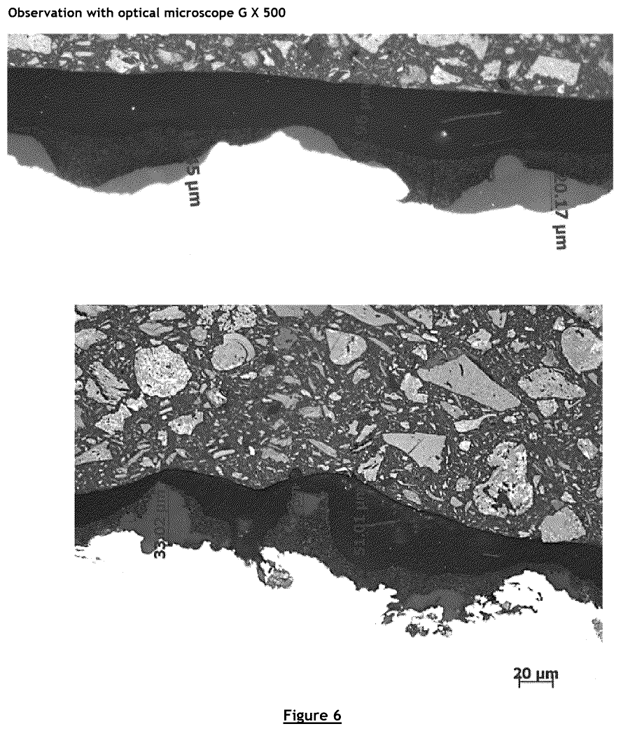

FIG. 5: Microtomography analysis, Example 2

FIG. 6: Physico-chemical SEM-EDX analysis of 2D cross-sectional images of counter-example 3

### Mechanical Durability/Scratch Resistance Evaluation Tests

The excellent mechanical performances of this coating are evaluated using the hot blade test (FIG. 1).

This test method evaluates the scratch resistance of a coating by means of a movable system composed of 3 hard points (ballpoint pens). This test, which is also referred to as the “tiger paw test”, induces rotation around its axis and describes an epicyclic movement on the coated surface. Damage to the coating (appearance of metal spots, scratches, coating delamination) is evaluated visually after different time cycles.

Non-stick tests using burnt milk are carried out after each of the preceding cycles.

Upon completion of this test, three items of output data can be evaluated:
Delamination of the fluorinated coating on a metal surface or fluorinated interlayers after a test time (duration).
Appearance of scratches to the metal: Scratch to the metal after a test time (duration).
Loss of the non-stick property (AA=0) after test time (duration).

### Evaluation of the Adhesion of a Layer of Intermediate or Primer on a Smooth Aluminum Substrate

An ISO 2409 cross-cut test is carried out, followed by immersion of the coated article for 18 hours (consisting of 3 cycles of 3 hours in boiling water alternating with 3 cycles of 3 hours in oil at 200° C.). Next, the non-stick coating is checked for delamination.

The following rating is used: no square must be delaminated to obtain a rating of 100 (excellent adhesion); in the event of delamination, the value recorded is equal to the rating of 100 minus the number of detached squares.

Tests to Evaluate Topography, Surface Condition and Surface Roughness Using Optical Analysis with a Bruker Alicona Instrument

The system used is a highly accurate three-dimensional optical measuring machine. It is an Alicona InfiniteFocus G5 instrument by Bruker.

It combines the advantages of coordinate measurement technology with those of surface measurement, making it possible to measure the size, position, shape and roughness of parts with a single sensor.

The profile measurements are carried out in accordance with DIN EN ISO 4287, ISO 11562, ASME B46 1-2002 (2D roughness, surface condition, profile method).

The surface measurements are carried out in accordance with DIN EN ISO 25178 (3D roughness, surface texture).

The roughness is measured in 2D according to the roughness profile and defined by a key parameter, Ra, with the following definition of parameters relevant to the tests in question: Ra: average profile roughness (the sensitivity of the 2D roughness measurement is 0.1 μm).

The roughness is also measured in 3D by a high-resolution optical system and according to the profile of the area under the roughness profile and defined in particular by the following parameters: Sdr and Ssk, with the definition below of the parameters relevant for the tests in question:
Sdr: developed surface (%)
Ssk: morphology and asymmetry of the profiles of the peaks

The measurement sensitivity for 3D roughness is 0.1 μm

### Porosity Evaluation Tests Using X-Ray Microtomography Analysis

X-ray microtomography is a powerful, non-destructive testing technique that generates a magnified 3D image of a sample. Its operation is based on the same physical principles as medical scanning, and provides better spatial resolution, to less than a micrometer. This technique consists in acquiring a large number of radiographic projections of a sample from multiple angles to digitally reconstruct a 3D map of the phases that make up the sample.

X-ray radiography involves passing an X-ray beam through a sample and measuring the spatial distribution of the beam's intensity when it exits the sample, on a detector.

Various X-ray sources can be used for X-ray microtomography, including X-ray tubes and synchrotrons. These two types of sources have different characteristics, which influence microtomographic acquisitions.

For the analyses in question, the source used is the synchrotron, which, unlike X-ray tubes, emits a parallel X-ray beam. The radiographic projections are enlarged by the detector. This incorporates an optical system that can be adjusted to select the desired pixel size. It is therefore not necessary to bring the sample closer to the source in order to improve acquisition resolution; this helps overcome limitations on the size of objects and offers the possibility of sub-μm pixel sizes.

The X-rays used in radiography have sufficient energy to pass through most materials; they are poorly absorbed by lightweight elements and can pass through considerable thicknesses of material. When an X-ray beam passes through a sample, it is affected by various physical mechanisms that result in a decrease in its intensity until it leaves the sample. This attenuation is proportional to the thickness and attenuation coefficient of the phases through which it passes. Therefore, each unitary sensor in the detector measures an intensity that depends on the path taken by the beam through the material. These local intensity measurements are then digitized and converted to form a grayscale image referred to as a radiograph or radiographic projection.

Radiographic systems can also generate an enlargement of the projected image, using the geometry of the beam emitted by the X-ray source or via the detection system.

Low-density regions correspond to low gray levels (close to black), while high-density regions correspond to high gray levels (close to white). These contrasting gray levels enable phases of different densities to be distinguished.

The distribution of gray levels in microtomography data can be displayed on a histogram. In particular, the histogram of gray levels provides information on the volume fractions of the different phases of the sample.

### Tests for Evaluating the Chemical Composition by SEM/EDX Analysis

The SEM is a multi-purpose, multi-functional piece of equipment that provides images of the surface structure and morphology of the material with a resolution of a few nm and a very high depth of field; it also provides qualitative (BSE) and quantitative (EDX, lateral resolution around 1 μm) chemical information.

EDX is a technique in which the X-rays generated by the interaction between the electron beam and the sample are analyzed to give an elemental composition of the sample. An EDX spectrum comprises peaks that correspond to the characteristic radiation of a specific element. A quantitative chemical characterization of the sample is deduced from the EDX spectrum.

The SEM/EDX analysis technique combines topographic surface analysis using a scanning electron microscope (SEM) with chemical analysis using energy-dispersive X-ray spectroscopy (EDX).

The principle of SEM is based on the detection of secondary electrons. A beam of electrons (referred to as primary electrons) comes into contact with the sample surface. When they collide with atoms on the surface, the primary electrons can give up energy to electrons in the upper layers of these atoms. These electrons are then ejected and are referred to as secondary electrons. Analyzing these electrons, which come from the surface layers, provides information on topography. When the primary electrons collide with the atoms, the latter can enter an excited state. When they return to a stable state, they emit X-rays whose wavelength is characteristic of the nature of the atom. Therefore, analyzing these X-rays provides information on the chemical nature of the sample.

### The Flame Spraying Thermal Spraying Method

Raw materials

PEEK (polyetheretherketone) is manufactured and sold under the brand name VICTREX VICOTE PEEK® 703 with a D50 volume diameter of 25 μm, a glass transition temperature of 143° C. and a melting temperature of 343° C.

PEEK (polyetheretherketone) is manufactured and sold under the brand name VICTREX VICOTE PEEK® 702 with a D50 volume diameter of 50 μm, a glass transition temperature of 143° C. and a melting temperature of 343° C.

PEEK (polyetheretherketone) is manufactured and sold under the brand name SOLVAY KETASPIRER 880SFP with D50 and D90 volume diameters of 30 μm and 55 μm respectively, a glass transition temperature of 143° C. and a melting temperature of 343° C.

PEEK (polyetheretherketone) in aqueous dispersion with fluorinated resins, in a 70/30 mass ratio, is manufactured and sold under the brand name VICTREX VICOTE® F815. The solid content of such an aqueous dispersion is of the order of 30%.

Silicon carbide (brand name SIKA ABR I F500) with a D50 diameter=12.8 μm, excellent thermal conductivity (up to 490 W·m⁻¹·K⁻¹).
Equipment: Castolin Eutectic CastoDyn DS 8000 flame spray torch with flame nozzle reference Castolin Eutectic module SSM 40.
The speed of movement of the torch is 150 mm to 200 mm/sec
Sulzer Metco 9MPE-CL twin powder feeder, flow rate of the powder mixture: varies from 2 g to 60 g/min
Propellant gas: Nitrogen
Combustible gas: acetylene, varies from 10 l/min to 16 l/min and acetylene pressure varies from 0.5 bar to 1 bar
Combustible gas: oxygen, varies from 10 l/min to 20.0 l/min and oxygen pressure varies from 3 bar to 5 bar
The temperature of the support during the application of the hard base: greater than or equal to room temperature (of the order of 20° C. to 200° C.)
Torch-to-part application distance, between 10 cm and 20 cm
Rotational speed of the parts, between 500 rpm and 1,500 rpm
PTFE requirement: complex formulation applied by gun spraying (roller coating or screen printing)

### The Cold Spraying Thermal Spraying Method

The cold spray method makes it possible to obtain uniform, solid, thick deposits on the surfaces of substrates to be coated. The cold spray principle is based on the high-speed spraying of powder particles, which, upon colliding with the substrate, undergo physical deformation. A pressurized gas stream (from 0.1 MPa to 5 MPa) is heated (from 25° C. to 1,000° C.) then injected into a de Laval (convergent-divergent) nozzle. In this nozzle, the gas is accelerated to supersonic speeds. The powder is injected into the gas stream upstream or downstream of the nozzle. The gas stream carries the powder particles at high speed to the substrate. If their kinetic energy is sufficient, both the particles and the substrate will deform on impact. Under deformation, the particles adhere to the substrate via mechanical bonds and, depending on their nature, via chemical or metallurgical bonds. Subsequent particles stack up on the previous layers, forming a deposit of greater or lesser thickness. The sprayed particles remain in a solid state.

### Description of the Spraying Device:

The cold spray equipment used is a CGT kinetics 3000 model coupled with a PF4000 powder feeder. The pressure range is from 1 MPa to 3 MPa and the temperature range from 300° C. to 500° C.

The gas used is nitrogen. Spraying is carried out with an “MOC24” tungsten carbide nozzle with a diameter <1 mm, fastened perpendicular to the samples and kept at 80 mm from the substrates. An illumination speed of 300 mm·s−1 with surfacing pitch of 1 mm.

### Example 1: 70% PEEK/30% SiC

A cooking utensil according to the invention with a discontinuous and macroporous hard base polymer
A cap made of aluminum of thickness 45/10^{th} is degreased and then shot blasted or sandblasted before undergoing an appropriate surface treatment to eliminate organic contaminants. The roughness has an Ra of the order of 5 μm. This cap is preheated to a maximum temperature of 100° C., preferably between 60° C. and 90° C., and used to apply a mixture of PEEK/SiC powder from the torch. The key 2D and 3D roughness parameters are as follows:
Ra is of the order of 5 μm.
Ssk: <<0

ISO 4287

Mean

Amplitude parameters-Prof

| | | |
|---|---|---|
| Ra | μm | 4.92 |
| Rsk | | −0.199 |
| Rt | μm | 30.0 |

Parameters linked to peaks-Pro

| | | |
|---|---|---|
| RPc | 1/mm | 5.02 |

ISO 25178
Height parameters

| | | |
|---|---|---|
| Sa | 5.90 | μm |
| Sz | 57.7 | μm |
| Ssk | −0.267 | |
| Sq | 7.44 | μm |
| Spd | 38.3 | 1/mm2 |
| Spc | 37.9 | 1/mm |

Hybrid parameters

| | | |
|---|---|---|
| Sdr | 4.73 | % |

Function parameters (gen.

| | | |
|---|---|---|
| Sxp | 30.3 | μm |

PEEK (polyetheretherketone) is manufactured and sold under the brand name VICTREX VICOTE PEEK® 703 with a D50 diameter=25 μm.

Silicon carbide (brand name SIKA ABR I F500) has a D50 diameter=12.8 μm, excellent thermal conductivity (up to 490 W·m⁻¹·K⁻¹).

The flame spray thermal method is used to obtain a discontinuous deposit of the mixture of the two above powders in a 70/30 mass ratio and in order to deposit a thickness of the order of 50 μm to 80 μm and approximately 60 μm.

A layer with very high porosity is obtained, owing to an accumulation of partially melted PEEK particles.

The 3D roughness of the surface of the shot blasted frying pan after flame spray deposition of the PEEK/SiC powder mixture was observed. The presence of peaks with maximum amplitudes of the order of 150 μm and a few zones with lower amplitude around 30-50 μm was observed. White zones which represent the silicon carbide particles were also observed.

The key 2D (ISO 4287) and 3D roughness parameters are as follows:
Ra=15.5 μm.
Ssk=0.06.

| | Center | Side |
|---|---|---|
| Ra | 14.496 | 15.930 |
| Rq | 18.18 | 20.639 |
| Rt | 118.282 | 168.701 |
| Rz | 109.811 | 138.639 |
| Rmax | 118.282 | 162.804 |
| Rp | 59.457 | 97.588 |
| Rv | 58.825 | 71.113 |
| Rp5 | 55.188 | 73.032 |
| Rv5 | 54.623 | 65.607 |
| Rc | 54.586 | 68.924 |
| Rsm | 227.916 | 276.574 |
| Rsk | −0.005 | 0.072 |
| Rdq | 1.739 | 1.927 |
| Rt/Rz | 1.077 | 1.220 |
| Sa | 14.164 | 16.510 |
| Sq | 17.941 | 21.345 |
| Sp | 92.455 | 121.783 |
| Sv | 78.164 | 88.425 |
| Sz | 170.618 | 210.209 |
| S10z | 161.579 | 200.171 |
| Ssk | 0.134 | 0.052 |
| Sku | 3.171 | 3.634 |
| Sdq | 2.617 | 3.005 |
| Sdr | 227.925 | 294.468 |
| FLTt | 170.618 | 210.209 |

This disc prepared as such is successively covered with a hard layer and upper layers made from PTFE.

After a single firing operation at 415° C., the coating has a surface that is slightly rough to the touch and does not crack.

The spray-coated or screen printed fluorinated coating is impregnated into the microporosity of the sublayer, creating a very mechanically strong composite after co-fusion of the particles of PTFE and PEEK, without the need for post-treatment (hot pressing, etc.).

During the PEEK melting phase, above 320-350° C., PTFE fibrils coalesce and melt around the PEEK, creating an interpenetrating network of the macromolecular chains of these two polymers.

This composite has excellent thermo-mechanical properties.

Physico-chemical analysis of the surface by means of SEM/EDX analysis and X-ray microtomography of the surface and cross section of the product also shows the macroporosity of this layer.

The macroporosity identified in 2D by physico-chemical analysis of the cross section using SEM-EDX is confirmed by analyzing this sample by X-ray microtomography (Synchrotron) (FIG. 2).

Analysis of the images shows a fairly regular coating layer with very variable dimensions of the average equivalent pore diameter.

The calculated overall closed porosity fraction is 10.5% in the complete coating.

The average equivalent pore diameter of the hard sublayer is 14.9 μm, with greater pore distribution on the metal surface side, of the order of 60% of the pore volume which is contained in 50 μm of the PEEK/SiC layer (FIG. 3).

Raw Materials for Manufacturing the Fluorinated Coatings that are Applied to the Hard Layer Made from PEEK/SiC
Heterocyclic polymer resins:
   Polyamide-imide (PAI) resin with 29% solids in N-ethylpyrrolidone (NEP), marketed by HUNTSMAN under the brand name RHODEFTAL 210, with a degree of polymerization of the order of 10 to 15
Anti-foaming agent and non-ionic surfactant
   Tego foamex K7 by Evonik
   Genapol X 089 by Clariant
Colloidal silica in 30% aqueous dispersion
Colloidal fluorinated resins in dispersion

### Development of the Fluorinated Liquid Coatings

Preparation of an aqueous composition of intermediate SF1 made from heterocyclic polymer with an amine and an unlabeled polar aprotic solvent.

An aqueous composition of intermediate SF1 is made comprising the following compounds in the respective quantities indicated below:

| | | |
|---|---|---|
| PAI resin with 29% solids in NEP | 327.9 | g |
| N-ethylpyrrolidone | 117.7 | g |
| Triethylamine | 32.8 | g |
| Demineralized water | 521.6 | g |
| TOTAL | 1000.0 | g |

The properties of the aqueous composition SF1 obtained in this way are as follows:
theoretical solids: 9.5%
solids measured in the composition: 9.3%

The substrate and the discontinuous hard sublayer as described above are coated with a non-stick multilayer coating made up of a fluorinated primer (4-6 μm), a fluorinated mid-coat (6-8 μm) that is dried for 4 minutes at 100° C. and a top layer (20-25 μm). The assembly is finally heated to 430° C. for 11 minutes. The compositions are as follows:

### Composition of the Primer (P)

An aqueous composition of bonding primer P is made comprising the following compounds in the respective quantities indicated below:

| | | |
|---|---|---|
| PTFE dispersion | 30.5 | g |
| Carbon black dispersion | 3.5 | g |
| Composition of intermediate SF1 (9.5% solids) | 47.2 | g |
| Non-ionic surfactant system | 5.1 | g |
| Colloidal silica | 11.0 | g |
| NH4OH | 1.4 | g |
| Demineralized water | 1.3 | g |
| TOTAL | 100.0 | g |

The properties of the primer composition P1 obtained in this way are as follows:
theoretical solids in the composition: 27.6%
viscosity (in 2.5 cup in accordance with DIN EN ISO 2433/ASTM D5125): 55 sec

### Composition of the Mid-Coat (MD)

An aqueous composition of bonding primer P is made comprising the following compounds in the respective quantities indicated below:

| | | |
|---|---|---|
| PTFE dispersion | 46.3 | g |
| PFA dispersion | 15.8 | g |
| Carbon black dispersion | 3.5 | g |
| Composition of intermediate SF1 (9.5% solids) | 15.7 | g |
| Non-ionic surfactant system | 5.1 | g |
| Colloidal silica | 11.0 | g |
| NH4OH | 1.4 | g |
| Demineralized water | 1.2 | g |
| TOTAL | 100.0 | g |

The properties of the composition of the mid-coat MD obtained in this way are as follows:
theoretical solids in the composition: 32%
viscosity (in 2.5 cup in accordance with DIN EN ISO 2433/ASTM D5125): 58 sec

### Top Layer Composition (F)

| | | |
|---|---|---|
| PTFE dispersion (60% solids) | 80.60 | g |
| PFA dispersion (50% solids) | 0.50 | g |
| Carbon black (25% solids) | 0.02 | g |
| Spreading agents (surfactants) | 2.23 | g |
| Water | 8.02 | g |
| Xylene | 6.50 | g |
| Acrylic copolymer >95% | 0.60 | g |
| Triethanolamine | 1.33 | g |
| Decorative metal flakes | 0.20 | g |
| Total | 100.00 | g |

### Example 2: 100% PEEK

A cooking utensil according to the invention with a discontinuous hard base polymer
A cap made of aluminum of thickness 45/10^{th} is degreased and then shot blasted or sandblasted before undergoing an appropriate surface treatment to eliminate organic contaminants. The roughness has an Ra of the order of 5 μm, the surface condition is described above. This cap is preheated to a temperature of 100° C., approximately between 60° C. and 90° C., and used to apply a PEEK powder with a flame spray method.

PEEK (polyetheretherketone) is manufactured and sold under the brand name VICTREX VICOTE PEEK® 703 with a D50 volume diameter=25 μm.

The flame spray thermal method is used to obtain a discontinuous deposit of the above powder and in order to deposit a thickness of this layer of the order of 50 μm to 60 μm.

The 3D roughness of the surface of the shot blasted frying pan after flame spray deposition of the PEEK powder was observed.

The key 2D (ISO 4287) and 3D roughness parameters are as follows:
Ra is of the order of 16 μm.
Ssk >>0

ISO 4287

Mean

Amplitude parameters-Prof

| | | |
|---|---|---|
| Ra | μm | 16.2 |
| Rz | μm | 87.1 |
| Rsk | | −0.163 |
| Rt | μm | 101 |
| RPc | 1/mm | 7.47 |

This disc prepared as such is successively covered with a hard layer and upper layers made from PTFE as described above.

After a single firing operation at 415° C., the coating has a surface that is slightly rough to the touch and does not crack.

The physico-chemical analysis of the surface by means of SEM/EDX analysis is shown in FIG. 4.

A discontinuous layer of PEEK of the order of 70 μm is observed, with macroporosity with an average equivalent pore diameter of the hard sublayer of the order of magnitude of ten microns.

The macroporosity identified in 2D by physico-chemical analysis of the cross section using SEM-EDX is confirmed by cross-sectional analysis of this sample by X-ray microtomography (Synchrotron) (FIG. 5).

Image analysis shows a fairly irregular coating layer with very variable pore dimensions.

The calculated overall closed porosity fraction is 10.5% in the complete coating.

The average equivalent pore diameter of the hard sublayer is 11.1 μm.

This disc prepared as such is successively covered with a hard layer and upper layers made from PTFE as described above.

After a single firing operation at 415° C., the coating has a surface that is slightly rough to the touch and does not crack.

### Example 3: 72% PEEK/25% SiC/3% Pigment

A cooking utensil according to the invention with a discontinuous and macroporous hard base polymer
A cap made of aluminum of thickness 45/10^{th} is degreased and then shot blasted or sandblasted before undergoing an appropriate surface treatment to eliminate organic contaminants. The roughness has an Ra of the order of 5 μm. This cap is preheated to a temperature of 100° C., approximately between 60° C. and 90° C., and used to apply a mixture of PEEK/SiC/colored pigment powder from the torch.

PEEK (polyetheretherketone) is manufactured and sold under the brand name VICTREX VICOTE PEEK® 703 with a D50 volume diameter=25 μm.

Silicon carbide (brand SIKA ABR I F500) with a D50 volume diameter=12.8 μm The pigment is graphite in powder form.

The flame spray thermal method is used to obtain a discontinuous deposit of the mixture of the three above powders in a mass ratio of 72/25/3 respectively and in order to deposit a mass to achieve a thickness of this layer of the order of 50 μm to 60 μm.

The 3D roughness of the surface of the shot blasted frying pan after flame spray deposition of the PEEK/SiC powder was observed.

The key 2D (ISO 4287) and 3D roughness parameters are as follows:
Ra=15.2.
Ssk=0.09.

| | Center | Side |
|---|---|---|
| Ra | 14.496 | 15.930 |
| Rq | 18.18 | 20.639 |
| Rt | 118.282 | 168.701 |
| Rz | 109.811 | 138.639 |
| Rmax | 118.282 | 162.804 |
| Rp | 59.457 | 97.588 |
| Rv | 58.825 | 71.113 |
| Rp5 | 55.188 | 73.032 |
| Rv5 | 54.623 | 65.607 |
| Rc | 54.586 | 68.924 |
| Rsm | 227.916 | 276.574 |
| Rsk | −0.005 | 0.072 |
| Rdq | 1.739 | 1.927 |
| Rt/Rz | 1.077 | 1.220 |
| Sa | 14.164 | 16.510 |
| Sq | 17.941 | 21.345 |
| Sp | 92.455 | 121.783 |
| Sv | 78.164 | 88.425 |
| Sz | 170.618 | 210.209 |
| S10z | 161.579 | 200.171 |
| Ssk | 0.134 | 0.052 |
| Sku | 3.171 | 3.634 |
| Sdq | 2.617 | 3.005 |
| Sdr | 227.925 | 294.468 |
| FLTt | 170.618 | 210.209 |

This disc prepared as such is successively covered with a hard layer and upper layers made from PTFE as described above.

After a single firing operation at 415° C., the coating has a surface that is slightly rough to the touch and does not crack.

### Example 4: 70% PEEK/30% SIC

A cooking utensil according to the invention with a discontinuous and macroporous hard base polymer
A cap made of aluminum of thickness 45/10^{th} is degreased and then shot blasted or sandblasted before undergoing an appropriate surface treatment to eliminate organic contaminants. The roughness has an Ra of the order of 5 μm. This cap is preheated to a temperature of 100° C., approximately between 60° C. and 90° C., and used to apply a mixture of PEEK/SiC powder from the torch.

PEEK (polyetheretherketone) is manufactured and sold under the brand name VICTREX VICOTE PEEK® 703 with a D50 volume diameter=25 μm.

Silicon carbide (brand SIKA ABR I F500) with a D50 diameter=12.8 μm

The flame spray thermal method is used to obtain a discontinuous deposit of the mixture of the two above powders in a mass ratio of 70/30 respectively and in order to deposit a mass to achieve a thickness of this layer of the order of 60 μm to 80.

The 3D roughness of the surface of the shot blasted frying pan after flame spray deposition of the PEEK/SiC powder mixture was observed.

Analysis of the topography of this sample on a scale of 200 μm shows a certain degree of macroporosity in the micron range.

The 3D roughness of the surface of the shot blasted frying pan after flame spray deposition of the PEEK/SiC powder was observed.

The key 2D (ISO 4287) and 3D roughness parameters are as follows:
Ra=35.
Ssk=0.15.

This disc prepared as such is successively covered with a hard layer and upper layers made from PTFE as described above.

After a single firing operation at 415° C., the coating has a surface that is slightly rough to the touch and does not crack.

### Example 5: 70% PEEK/30% SiC

A cap made of aluminum of thickness 45/10^{th} is degreased and then shot blasted or sandblasted before undergoing an appropriate surface treatment to eliminate organic contaminants. The roughness has an Ra of the order of 5 μm, the surface condition is described above. This cap is preheated to a temperature of 260° C., between approximately 130° C. and 210° C., and used to apply a mixture of PEEK and silicon carbide powders in a 70/30 mass ratio, using a cold spray method (gas dynamic cold spraying).

PEEK (polyetheretherketone) is manufactured and sold under the brand name VICTREX VICOTE PEEK® 703 with a D50 volume diameter=25 μm.

The cold spray method is used to obtain a discontinuous deposit of the PEEK/SiC powder and in order to deposit a thickness of this layer of the order of 50 μm to 60 μm.

The 3D roughness of the surface of the shot blasted frying pan after cold spray deposition of the PEEK/SiC powder was observed.

The key 2D (ISO 4287) and 3D roughness parameters are as follows:
Ra=12 μm.
Ssk=0.15.

This disc prepared as such is successively covered with a hard layer and upper layers made from PTFE as described above.

After a single firing operation at 415° C., the coating has a surface that is slightly rough to the touch and does not crack.

This disc prepared as such is successively covered with a hard layer and upper layers made from PTFE as described above.

After a single firing operation at 415° C., the coating has a surface that is slightly rough to the touch and does not crack.

### Example 6: 70% PEEK/30% SiC

A cap made of aluminum of thickness 45/10^{th} is degreased and then shot blasted or sandblasted before undergoing an appropriate surface treatment to eliminate organic contaminants. The roughness has an Ra of the order of 5 μm. This cap is preheated to a temperature of 100° C., approximately between 60° C. and 90° C., and used to apply a mixture of PEEK/SiC powder from the torch.

PEEK (polyetheretherketone) is manufactured and sold under the brand name SOLVAY KETASPIRER 880SFP with D50 and D90 volume diameters of 30 μm and 55 μm respectively. Silicon carbide (brand SIKA ABR I F500) with a D50 volume diameter=12.8 μm

The flame spray thermal method is used to obtain a discontinuous deposit of the mixture of the two above powders in a mass ratio of 70/30 respectively and in order to deposit a mass to achieve a thickness of this layer of the order of 30 μm to 40 μm.

A sublayer with very high porosity is obtained, owing to an accumulation of partially melted PEEK particles.

The 3D roughness of the surface of the shot blasted frying pan after flame spray deposition of the PEEK/SiC powder was observed.

The key 2D (ISO 4287) and 3D roughness parameters are as follows:
Ra=20.0 μm.
Ssk=0.395.

| | Center | Site |
|---|---|---|
| Ra | 17.065 | 23.328 |
| Rg | 21.814 | 29.727 |
| Rt | 163.335 | 198.332 |
| Rz | 137.106 | 169.166 |
| Rmax | 160.153 | 192.814 |
| Rp | 88.817 | 128.704 |
| Rv | 74.517 | 69.629 |
| Rc | 70.404 | 89.232 |
| Rsm | 252.024 | 261.157 |
| Rsk | 0.131 | 0.565 |
| Rku | 3.401 | 3.456 |
| Rdq | 1.872 | 2.390 |
| Rt/Rz | 1.191 | 1.173 |
| Sa | 17.382 | 24.214 |
| Sq | 22.25 | 30.808 |
| Sp | 137.848 | 168.897 |
| Sv | 91.722 | 88.822 |
| Sz | 229.569 | 257.719 |
| S10z | 206.589 | 244.897 |
| Ssk | 0.198 | 0.592 |
| Sku | 3.525 | 3.561 |
| Sdq | 2.747 | 3.316 |
| Sdr | 256.553 | 367.633 |
| FLTt | 229.569 | 257.719 |

This disc prepared as such is successively covered with a hard layer and upper layers made from PTFE as described above.

After a single firing operation at 415° C., the coating has a surface that is slightly rough to the touch and does not crack.

### Example 7: 70% PEEK/30% SiC

A cap made of aluminum of thickness 45/10^{th} is degreased and then shot blasted or sandblasted before undergoing an appropriate surface treatment to eliminate organic contaminants. The roughness has an Ra of the order of 5 μm. This cap is preheated to a temperature of 100° C., approximately between 60° C. and 90° C., and used to apply a mixture of PEEK/SiC powder from the torch.

PEEK (polyetheretherketone) is manufactured and sold under the brand name VICTREX VICOTE PEEK® 702 with a D50 volume diameter=50 μm.

Silicon carbide (brand SIKA ABR I F500) with a D50 volume diameter=12.8 μm

The flame spray thermal method is used to obtain a discontinuous deposit of the mixture of the two above powders in a mass ratio of 70/30 respectively and in order to deposit a mass to achieve a thickness of this layer of the order of 50 μm to 60 μm.

A sublayer with very high porosity is obtained, owing to an accumulation of partially melted PEEK particles.

The 3D roughness of the surface of the shot blasted frying pan after flame spray deposition of the PEEK/SiC powder mixture was observed.

The key 2D (ISO 4287) and 3D roughness parameters are as follows:
Ra=34 μm.
Ssk=2.

This disc prepared as such is successively covered with a hard layer and upper layers made from PTFE as described above.

After a single firing operation at 415° C., the coating has a surface that is slightly rough to the touch and does not crack.

### Counter-Example 1

A cap made of aluminum of thickness 45/10^{th} is degreased and then shot blasted or sandblasted before undergoing an appropriate surface treatment to eliminate organic contaminants. Ra is of the order of 5 μm.

This disc prepared as such is covered with upper layers made from PTFE as described above.

After a single firing operation at 415° C., the coating has a surface that is slightly rough to the touch and does not crack.

### Counter-Example 2

Cooking utensil according to the method below
A cap made of aluminum of thickness 45/10^{th} is degreased and then shot blasted or sandblasted before undergoing an appropriate surface treatment to eliminate organic contaminants. The roughness has an Ra of the order of 5 μm, the surface condition is described above.

A liquid coating made from an aqueous dispersion of PEEK by the company VICTREX F815 is applied by spray coating onto the aluminum surface. This layer is first sintered at 415° C., then cooled to room temperature.

The thickness of this first layer without or with fluorinated resin is between 50 μm and 150 μm.

Once the surface of this coating has cooled to room temperature, the fluorinated upper layers are sprayed on. After a second firing operation at 415° C., the coating has a surface that is very rough to the touch and very thick, with a thickness in excess of 80 μm.

The key 2D (ISO 4287) and 3D roughness parameters are as follows:
Ra is of the order of 3 μm.
Ssk >>0

| Thickness (μm) | 50 μm |
|---|---|
| Ra (μm) | 300 |
| Sa (μm) | 3.695 |
| Ssk | −0.516 |
| Sdr | 2.286% |

### Counter-Example 3

A cap is preheated to a temperature of 100° C., approximately between 60° C. and 90° C., and used to apply a mixture of PEEK powder from the torch.

PEEK (polyetheretherketone) is manufactured and sold under the brand name VICTREX VICOTE PEEK® 703 with a D50 volume diameter=25 μm.

The flame spray thermal method is used to obtain a discontinuous deposit of this above powder in a mass ratio of 100% and in order to deposit a mass of the order of 0.7 g to achieve a thickness of this layer of the order of 15 μm to 25 μm.

The 3D roughness of the surface of the shot blasted frying pan after flame spray deposition of the PEEK/SiC powder mixture was observed.

The key 2D (ISO 4287) and 3D roughness parameters are as follows:
Ra=5.8 μm.
Ssk=0.45.

| | Measure- | Measure- | Measure- | | Standard |
|---|---|---|---|---|---|
| | ment 1 | ment 2 | ment 3 | Average | deviation |
| Ra | 6.525 | 5.295 | 5.75 | 5.857 | 0.446 |
| Rq | 8.713 | 6.755 | 7.596 | 7.688 | 0.683 |
| Rt | 88.567 | 47.462 | 72.501 | 69.510 | 14.699 |
| Rz | 62.618 | 38.407 | 51.053 | 50.693 | 8.190 |
| Rmax | 84.595 | 47.462 | 69.958 | 67.338 | 13.251 |
| Rp | 63.228 | 27.58 | 49.205 | 46.671 | 12.727 |
| Rv | 25.339 | 19.882 | 23.296 | 22.839 | 1.971 |
| Rc | 34.56 | 22.456 | 27.009 | 28.008 | 4.368 |
| Rsm | 414.01 | 279.569 | 338.496 | 344.025 | 46.657 |
| Rsk | 0.795 | 0.282 | 0.673 | 0.583 | 0.201 |
| Rku | 6.021 | 3.2 | 6.271 | 5.164 | 1.309 |
| Rdq | 0.614 | 0.441 | 0.529 | 0.528 | 0.058 |
| Rt/Rz | 1.414 | 1.236 | 1.42 | 1.357 | 0.080 |
| Sa | 5.924 | 5.759 | 5.888 | 5.857 | 0.065 |
| Sq | 7.715 | 7.58 | 7.639 | 7.645 | 0.047 |
| Sp | 126.65 | 88.568 | 80.319 | 98.512 | 18.758 |
| Sv | 39.561 | 36.196 | 50.154 | 41.970 | 5.456 |
| Sz | 166.21 | 124.764 | 130.473 | 140.482 | 17.152 |
| S10z | 154.468 | 108.978 | 109.098 | 124.181 | 20.191 |
| Ssk | 0.484 | 0.522 | 0.344 | 0.450 | 0.071 |
| Sku | 6.981 | 5.349 | 4.831 | 5.720 | 0.840 |
| Sdq | 0.731 | 0.736 | 0.717 | 0.728 | 0.007 |
| Sdr | 20.898 | 20.838 | 20.219 | 20.652 | 0.288 |
| FLTt | 166.21 | 124.764 | 130.473 | 140.482 | 17.152 |

Once the surface of this coating has cooled to room temperature, the fluorinated upper layers are sprayed on. This is followed by a second firing operation at 415° C.

This coating does not crack or lose adhesion.

The result is a sublayer with no visible porosity, and the partially melted PEEK particles form a highly discontinuous layer.

Physico-chemical SEM-EDX analyses of 2D cross-sectional images are shown in FIG. 6.

### Overview of Results

The table below clearly shows the advantage of using a discontinuous, hard macroporous sublayer made from PEEK and fillers applied by a flame spray thermal method made from a mixture of thermostable polymer resins made from PEEK and silicon carbide SiC, and pigment, without the presence of fluorinated resin in this first layer and without the need to pre-heat the caps to a high temperature (higher than 100° C.).

The non-stick performance of the complete coating with the upper layers made from fluorinated resins is good.

The appearance of scratching demonstrated by the tests used (hot blade test) is largely delayed or even non-existent for a configuration where the thickness of the sublayer (3) is between 15 μm and 80 μm, preferably between 30 μm and 80 μm.

This coating is obtained in a single sintering operation at 400-430° C. for 11 minutes, while maintaining excellent adhesion to the metal substrate and interlayer adhesion (no delamination of the coating during the hot blade test).

| | Flame spray | | | | | | |
|---|---|---|---|---|---|---|---|
| | method - | | Thickness | | | | |
| | Composition - | Thickness | of the | Number | | | |
| | Hard | of the | fluorinated | of | | Hot blade | |
| | PEEK/SiC | sublayer | layers | sintering | Adhesion | test: | Abrasion |
| Coating | sublayer | [μm] | [μm] | cycles | test | 2 hrs at 180° C. | test |
| Example 1 | PEEK (D 50 = | 50 μm to | 30-40 μm | 1 | 100 | Scratch to the | 30,000 |
| | 25 μm)/SiC: | 80 μm | | | excellent | metal at 7.5 | cycles |
| | 70/30 | | | | adhesion | hrs | (AA = 0) |
| | flame spray | | | | | No | No |
| | thermal | | | | | delamination | scratches |
| | method | | | | | of the | at 100,000 |
| | | | | | | fluorinated | cycles |
| | | | | | | coating | |
| | | | | | | AA = 0 to 6 hrs | |
| Example 2 | PEEK: 100% | 50 μm to | 30-40 μm | 1 | 100 | Scratch to the | 20,000 |
| | (D 50 = 25 μm) | 60 μm | | | excellent | metal at 4 hrs | cycles |
| | flame spray | | | | adhesion | Moderate | (AA = 0) |
| | thermal | | | | | delamination | No |
| | method | | | | | of the | scratches |
| | | | | | | fluorinated | at 100,000 |
| | | | | | | coating | cycles |
| | | | | | | AA = 0 at [symbol] | |
| | | | | | | 4.5 hrs | |
| Example 3 | PEEK (D 50 = | 50 μm to | 30-40 μm | 1 | 100 | Scratch to the | 28,000 |
| | 25 μm)/ | 60 μm | | | excellent | metal at 7 hrs | cycles |
| | SiC/pigment: | | | | adhesion | No delamination | (AA = 0) |
| | 72/25/3 | | | | | of the | No |
| | flame spray | | | | | fluorinated | scratches |
| | thermal | | | | | coating | at 100,000 |
| | method | | | | | AA = 0 to 6 hrs | cycles |
| Example 4 | PEEK (D 50 = | 60 μm to | 30-40 μm | 1 | 100 | Scratch to the | 15,000 |
| | 25 μm)/SiC: | 80 μm | | | excellent | metal at 8.5 hrs | cycles |
| | 70/30 | | | | adhesion | No delamination | (AA = 0) |
| | flame spray | | | | | of the | No |
| | thermal | | | | | fluorinated | scratches |
| | method | | | | | coating | at 100,000 |
| | | | | | | AA = 0 to 4 hrs | cycles |
| Example 5 | PEEK (D 50 = | 50 μm to | 30-40 μm | 1 | 75 | Scratch to the | 15,000 |
| | 25 μm)/SiC: | 60 μm | | | | metal at 3 hrs | cycles |
| | 70/30 | | | | | delamination | (AA = 0) |
| | the disc is | | | | | of the | No |
| | preheated to | | | | | fluorinated | scratches |
| | a maximum | | | | | coating | at 100,000 |
| | temperature | | | | | AA = 0 to 4 hrs | cycles |
| | of 260° C. | | | | | | |
| | cold spray | | | | | | |
| | method | | | | | | |
| Example 6 | PEEK | 30 μm to | 30-40 μm | 1 | 100 | Scratch to the | 80,000 |
| | KETASPIRE ® | 40 μm | | | excellent | metal at 6 hrs | cycles |
| | 880SFP (D 50 = | | | | adhesion | No delamination | (AA = 0) |
| | 30 μm)/SiC: | | | | | of the | No |
| | 70/30 | | | | | fluorinated | scratches |
| | flame spray | | | | | coating | at 100,000 |
| | thermal | | | | | AA = 0 to 6 hrs | cycles |
| | method | | | | | | |
| Example 7 | PEEK (D 50 = | 50 μm to | 30-40 μm | 1 | 100 | Scratch to the | 15,000 |
| | 50 μm)/SiC: | 60 μm | | | excellent | metal at 3 hrs | cycles |
| | 70/30 | | | | adhesion | No delamination | (AA = 0) |
| | flame spray | | | | | of the | No |
| | thermal | | | | | fluorinated | scratches |
| | method | | | | | coating | at 100,000 |
| | | | | | | AA = 0 to 4 hrs | cycles |
| Counter- | 0 | 0 | 30 μm to | 1 | 100 | Scratch to the | 15,000 |
| example 1 | | | 40 μm | | excellent | metal at 20 mins | cycles |
| | | | | | adhesion | delamination | (AA = 0) |
| | | | | | | of the | scratches |
| | | | | | | fluorinated | at 10,000 |
| | | | | | | coating at 15 | cycles |
| | | | | | | mins | |
| | | | | | | AA = 0 to 15 mins | |
| Counter- | No flame | 50 μm to | 30 μm to | 2 | 25 | delamination | 30,000 |
| example 2 | spray process | 150 μm | 40 μm | | | of the | cycles |
| | Spraying of an | | | | | fluorinated | (AA = 0) |
| | aqueous | | | | | coating at 1.5 hrs | scratches |
| | dispersion of | | | | | AA = 0 to 2 hrs | at 30,000 |
| | PEEK | | | | | | cycles |
| Counter- | PEEK: 100% | 15 μm to | 30 μm to | 1 | 100 | Scratch to the | 15,000 |
| example 3 | (D 50 = 25 μm) | 25 μm | 40 μm | | excellent | metal at 1 hr | cycles |
| | flame spray | | | | adhesion | delamination | (AA = 0) |
| | thermal | | | | | of the | No |
| | method | | | | | fluorinated | scratches |
| | | | | | | coating at 1 hr | at 50,000 |
| | | | | | | AA = 0 to 1 hr | cycles |

1-24. (canceled)

25. A culinary item comprising a hollow metal cap that comprises a bottom and a sidewall extending up from the bottom, said cap having a concave interior face designed to accept food products and a convex exterior face, said interior face being coated with a coating which consists successively, starting from the cap, of a hard sublayer, presenting pores, and a non-stick coating, the non-stick coating comprising at least one layer comprising at least one fluorocarbon resin, alone or in a mixture with at least one thermostable bonding resin that can withstand at least 200° C., wherein the hard sublayer is provided as a discontinuous layer, wherein said hard sublayer is made up of one or more non-fluorinated polymer materials chosen from polyaryletherketones (PAEK) and mixtures thereof, and wherein the average equivalent pore diameter in the hard sublayer is greater than 5 μm, wherein the hard sublayer has surface roughness Ra of between 8 μm and 100 μm and wherein the coating has an overall porosity fraction greater than 8%.

26. The culinary item as claimed in claim 25, wherein the hard sublayer further comprises fillers selected from hard inorganic fillers, conductive fillers and a combination thereof.

27. The culinary item as claimed in claim 25, wherein the hard sublayer further comprises less than 3% by weight of additives relative to the weight of said hard sublayer.

28. The culinary item as claimed in claim 25, wherein the average thickness of the hard sublayer is greater than 5 μm.

29. The culinary item as claimed in claim 25, wherein the average equivalent pore diameter in the hard sublayer is greater than 8 μm.

30. The culinary item as claimed in claim 25, wherein the median equivalent pore diameter in the hard sublayer is greater than 6 μm.

31. The culinary item as claimed in claim 25, wherein at least 1% of the pores by number in the hard sublayer have an equivalent pore diameter greater than 30 μm.

32. The culinary item as claimed in claim 25, characterized by an overall porosity fraction greater than 10% in the coating.

33. The culinary item as claimed in claim 25, wherein more than 50% of the pores' volume of the coating is contained in the hard sublayer.

34. The culinary item as claimed in claim 25, wherein the thickness of the coating is between 15 μm and 200 μm.

35. The culinary item as claimed in claim 27, wherein the additives are selected from the group consisting of pigments, surfactants, wetting agents and a mixture thereof.

36. The culinary item as claimed in claim 26, wherein the hard inorganic fillers are selected from the group consisting of silicon carbides particles, alumina particles, zirconia particles, graphite particles, carbon black particles, ceramic particles, and particles of one or more metal oxides.

37. The culinary item as claimed in claim 25, wherein the non-fluorinated polymer material or materials represent more than 50% by weight, by weight of the hard sublayer.

38. The culinary item as claimed in claim 37, wherein the non-fluorinated polymer material or materials represent more than 97% by weight of the hard sublayer.

39. The culinary item according to claim 25, wherein the hard inorganic fillers represent more than 20% by weight of the hard sublayer.

40. The culinary item as claimed in claim 25, wherein the hard sublayer has surface roughness Ra of between 10 μm and 60 μm.

41. The culinary item as claimed in claim 25, wherein the non-fluorinated polymer material of said hard sublayer is PEEK.

42. The culinary item as claimed in claim 25, wherein the fluorocarbon resin is selected from the group consisting of polytetrafluoroethylene (PTFE), copolymer of tetrafluoroethylene and perfluoro (propyl vinyl ether) (PFA), copolymer of tetrafluoroethylene and hexafluoropropylene (FEP) and mixtures thereof.

43. The culinary item as claimed in claim 25, wherein the bonding resin is chosen from polyamide-imides (PAI), polyetherimides (PEI), polyamides (PA), polyetherketones (PEK), polyetheretherketones (PEEK), polyethersulfones (PES), and polyphenylene sulfides (PPS), tannins and mixtures thereof.

44. The culinary item as claimed in claim 25, wherein the cap is:
a single-layer support made with:
from aluminum or aluminum alloy, cast aluminum, stainless steel, cast steel, or copper; or
a multilayer support comprising the following layers from the outside towards the inside:
ferritic stainless steel/aluminum/austenitic stainless steel, or
stainless steel/aluminum/copper/aluminum/austenitic stainless steel, or
a cap of cast aluminum, aluminum or aluminum alloys lined with an outer bottom of stainless steel.

45. A process for manufacturing a culinary item, comprising the following steps:
a) a step of providing a metal support comprising two opposing faces;
b) a step of shaping said support to give it the shape of a cap, which comprises a bottom and a sidewall extending up from the bottom, and thus defining a concave interior face food products and a convex exterior face, said step b) being carried out either before the step d) of producing the hard sublayer, or after the step e) of producing the non-stick coating;
c) optionally, a step of treating the interior face of the support in order to obtain a treated interior face that promotes the adhesion of a hard sublayer on the support;
d) a step of producing an adherent hard sublayer on said interior face or on said bottom of the support by thermal spraying of a powder or dispersion of a non-fluorinated polymer material chosen from polyaryletherketones (PAEK) and mixtures thereof, so as to form a discontinuous layer on said interior face of the cap;
e) a step of producing a non-stick coating on said hard sublayer formed in step d);
f) a single final sintering step.

46. The process as claimed in claim 45, wherein the thermal spraying is flame spraying or gas dynamic cold spraying.

47. The process as claimed in claim 45, wherein the material intended to be sprayed is a powdery material with a D50 particle size by volume of 5 μm to 60 μm.

48. The process as claimed in claim 45, wherein the step d) of producing the non-stick coating comprises a step of depositing, on said hard sublayer, at least one composition comprising a fluorocarbon resin.

49. The process as claimed in claim 48, wherein the step d) is carried out by spraying, spread coating, screen printing or roller coating.

50. A process as claimed in any one of claim 45, wherein the sintering step (f) is carried out in a furnace at a temperature of between 380° C. and 450° C.
